(19) United States
(12) Patent Application Publication
(10) Pub. No.: US 2014/0306563 A1
(43) Pub. Date: Oct. 16, 2014

(54) Mechanical-Electrical Integrated Electric Drive System

(71) Applicant: Hitachi Automotive Systems, Ltd., Hitachinaka-shi, Ibaraki (JP)

(72) Inventors: Kazuto Oyama, Hitachinaka (JP); Kosuke Suzuki, Hitachinaka (JP); Hideki Miyazaki, Hitachinaka (JP); Katsuhiro Hoshino, Hitachinaka (JP)

(21) Appl. No.: 14/360,788

(22) PCT Filed: Nov. 5, 2012
(86) PCT No.: PCT/JP2012/078562

§ 371 Date: May 27, 2014

(30) Foreign Application Priority Data
Nov. 28, 2011 (JP) 2011-259229

(51) Int. Cl. H02K 3/28; H02K 5/22

(52) U.S. Cl. CPC H02K 3/28; H02K 5/22
USPC 310/71

(57) ABSTRACT

Disclosed is a mechanical-electrical integrated electric drive system capable of returning common mode current from a rotary electric machine's side to a virtual neutral point of a power-conversion device inside the electric drive system, where the system comprises a rotary electric machine that includes a rotor, a stator having a stator core including armature windings, and a housing holding the stator and having AC terminals of the armature windings arranged thereon; a power conversion device that is fixed to the periphery of the housing and includes an inverter circuit and AC bus bars connecting the inverter circuit with the AC terminals; conductor rings that are arranged in contact with the stator core to collect common mode current deriving from stray capacitance of the stator; and a connection wire that connects the conductor bar to a virtual neutral point on the DC input side of the inverter circuit.

### TECHNICAL FIELD

The present invention relates to a mechanical-electrical integrated electric drive system in which a rotary electric machine and a power conversion device for driving the rotary electric machine are integrated into one body.

### BACKGROUND ART

Patent Document 1 describes an example of a power conversion device having a common mode noise reduction mechanism. The common mode noise (also called “common mode current”) is desired to be reduced since the common mode noise can cause malfunction to the power conversion device controlling the rotary electric machine. For example, the reduction of the common mode noise is desired in electric vehicles (traveling by using rotary torque generated by a rotary electric machine) and hybrid electric vehicles (traveling based on outputs of both an engine and a rotary electric machine) since the common mode noise exerts bad influence on the traveling performance of the vehicle. In consideration of the degree of freedom of the installation in vehicles, a mechanical-electrical integrated electric drive system formed by integrating the power conversion device and the rotary electric machine into one body is desirable.

### PRIOR ART DOCUMENTS

### Patent Document

Patent Document 1: Japanese Patent No. 3716152

### SUMMARY OF THE INVENTION

### Problem to be Solved by the Invention

However, in the invention described in Patent Document 1, a special noise reduction circuit is added to the power conversion device for the purpose of reducing the common mode current. The addition of the special noise reduction circuit leads to a cost rise and enlargement of the power conversion device. Further, the control of the power conversion device becomes complicated.

### Means for Solving the Problem

The invention of claim 1 provides a mechanical-electrical integrated electric drive system comprising: a rotary electric machine which includes a rotor, a stator having a stator core mounted with armature windings, and a housing holding the stator and having AC terminals of the armature windings arranged thereon; and a power conversion device which is fixed to the periphery of the housing and includes an inverter circuit and AC bus bars connecting the inverter circuit with the AC terminals. The mechanical-electrical integrated electric drive system comprises: a current-collecting member which is arranged in contact with the stator core to collect common mode current deriving from stray capacitance of the stator; and a connection wire which connects the current-collecting member to a virtual neutral point on the DC input side of the inverter circuit.

### Effect of the Invention

According to the present invention, the common mode current can be returned from the rotary electric machine's side to the virtual neutral point of the power conversion device inside the mechanical-electrical integrated electric drive system, by which the bad influence of the common mode current can be suppressed.

### BRIEF DESCRIPTION OF THE DRAWINGS

FIG. 1 is a block diagram showing control blocks of a hybrid electric vehicle having an electric drive system in accordance with an embodiment of the present invention.

FIG. 2 is an external perspective view of the electric drive system.

FIG. 3 is an external perspective view of the electric drive system.

FIG. 4 is a cross-sectional view of a rotary electric machine 900.

FIG. 5 is a perspective view of a stator 940 provided with a conductor ring 950c and conductor bars 950b.

FIG. 6 is a schematic diagram showing the inside of a power conversion device 200 in detail.

FIG. 7 is a block diagrams for explaining the circuitry of the power conversion device 200.

FIG. 8 is a schematic diagram in which representation of the stator 940 in FIG. 7 has been replaced with the stator 940 shown in FIG. 5.

FIG. 9 is a schematic diagram for explaining the configuration of an inverter circuit 140.

FIG. 10 is a schematic diagram showing an example of a conventional electric drive system in which the power conversion device 200 and the rotary electric machine 900 are provided separately.

FIG. 11 is a schematic diagram enlarging a part of FIG. 10 around shield cables 820U-820W.

FIG. 12 is a schematic diagram showing the flow of the common mode current in the conventional electric drive system.

FIG. 13 is a schematic diagram showing the flow of the common mode current in a case where the inverter circuit 140 and the rotary electric machine 900 are directly connected together by using AC bus bars.

FIG. 14 is a schematic diagram showing the conductor bars 950b and the conductor ring 950c arranged on the peripheral surface of a stator core 941.

FIG. 15 is a schematic diagram for explaining the flow of the common mode current in the embodiment.

FIG. 16 is a perspective view showing an example of a different configuration of the stator 940.

FIG. 17 is a cross-sectional view of the stator 940 shown in FIG. 16.

FIG. 18 is a perspective view showing another embodiment of the electric drive system.

### MODE FOR CARRYING OUT THE INVENTION

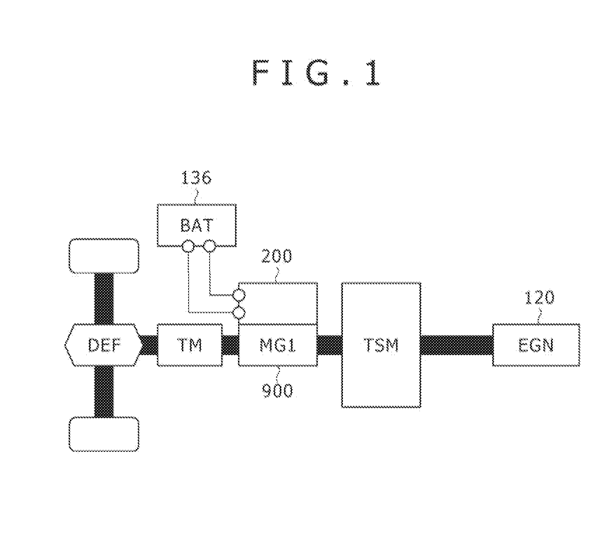

Referring now to the drawings, a description will be given in detail of a preferred embodiment of the present invention. FIG. 1 is a block diagram showing control blocks of a hybrid electric vehicle. While the following explanation will be given by taking an example of a hybrid electric vehicle traveling based on outputs of both an engine and a rotary electric machine, the mechanical-electrical integrated electric drive system according to this embodiment is applicable also to electric vehicles traveling by using rotary torque generated by a rotary electric machine.

An engine EGN and a rotary electric machine 900 generate torque for the traveling of the vehicle. The rotary electric machine 900 has not only the function of generating the rotary torque but also a function of converting mechanical energy (applied to the rotary electric machine 900 from the outside) into electric power. The rotary electric machine 900 (implemented by a synchronous machine or an induction machine, for example) operates either as a motor or as a generator depending on the operation mode as mentioned above. In cases where the rotary electric machine 900 is installed in a vehicle, the rotary electric machine 900 is desirable to generate high power with a small size, and thus a permanent magnet-type synchronous motor employing neodymium magnets or the like is suitable as the rotary electric machine 900. The permanent magnet-type synchronous motors, in which the heating of the rotor is less than that in induction motors, are suitable for the use for vehicles also from this viewpoint.

The output torque of the engine EGN is transmitted to the rotary electric machine 900 via a power transfer mechanism TSM, while the rotary torque from the power transfer mechanism TSM or the rotary torque generated by the rotary electric machine 900 is transmitted to the wheels via a transmission TM and a differential gear DEF. In contrast, during the operation of regenerative braking, rotary torque is transmitted from the wheels to the rotary electric machine 900. The rotary electric machine 900 generates AC power according to the supplied rotary torque. The generated AC power is converted by a power conversion device 200 into DC power as will be explained below, and the DC power charges a high-voltage battery 136. The electric power stored in the battery 136 is reused as energy for the traveling of the vehicle.

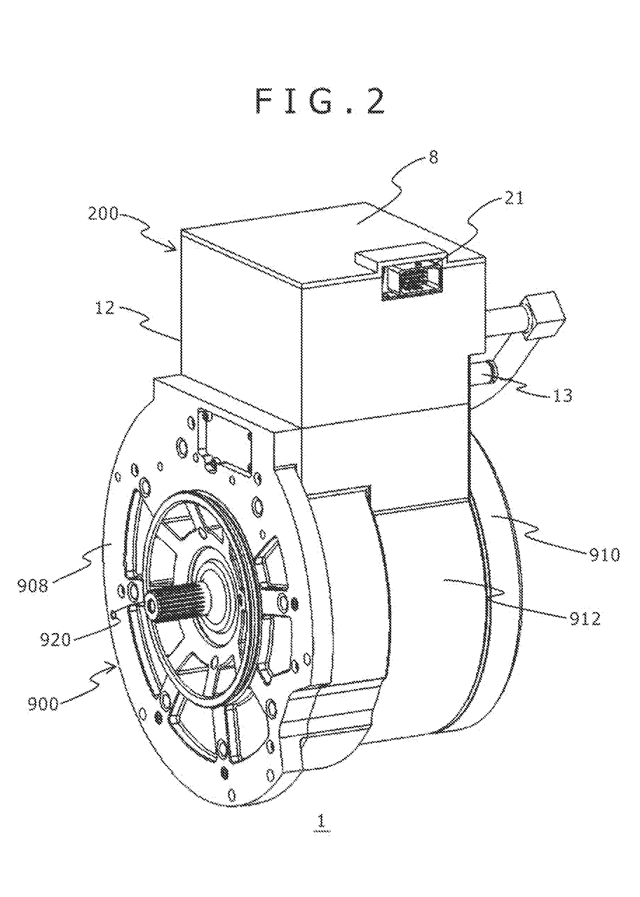

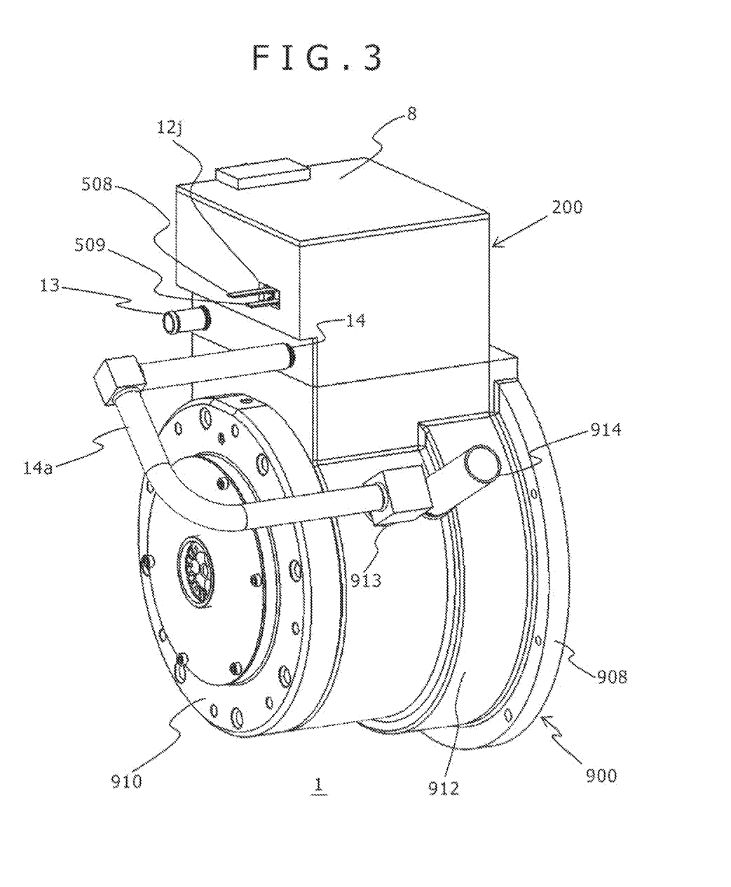

FIGS. 2 and 3 are external perspective views of the mechanical-electrical integrated electric drive system according to this embodiment. The electric drive system 1 is formed by combining the rotary electric machine 900 and the power conversion device 200 shown in FIG. 1 into an integral configuration. The rotary electric machine 900 has a housing 912, a front bracket 908 and a rear bracket 910 as its exterior parts. These exterior parts are generally formed by die casting, molding or casting of metal typified by aluminum.

The front bracket 908 and the rear bracket 910 are arranged at opposite ends of the housing 912 of the rotary electric machine 900 in its axial direction. A rotor shaft 920 protrudes from the center of the front bracket 908. The power conversion device 200 is fixed to the peripheral surface of the housing 912 (at a certain position in the radial direction) of the rotary electric machine 900.

A case 12 storing the circuit components of the power conversion device 200 is in a substantially cubic shape. A lid 8 is attached to the case 12 to cover the top opening of the case 12. The case 12 is fixed to the housing 912 of the rotary electric machine 900. The case 12 is made of electrically conductive material (metallic material such as die-cast aluminum in this embodiment). Communication of signals between the power conversion device 200 and an upper-level control device on the vehicle's side is performed via a connector 21.

A positive power supply terminal 509 and a negative power supply terminal 508 protrude from a hole 12j formed through the case 12 of the power conversion device 200. The DC electric power from the battery 136 is supplied to the power supply terminals 508 and 509. A channel for circulating a coolant is formed in the case 12. The coolant flows in through an inlet pipe 13 arranged on a side wall of the case 12 and is discharged through an outlet pipe 14. Electronic components (three-phase inverter circuit, etc.) inside the case 12 are cooled down by the coolant.

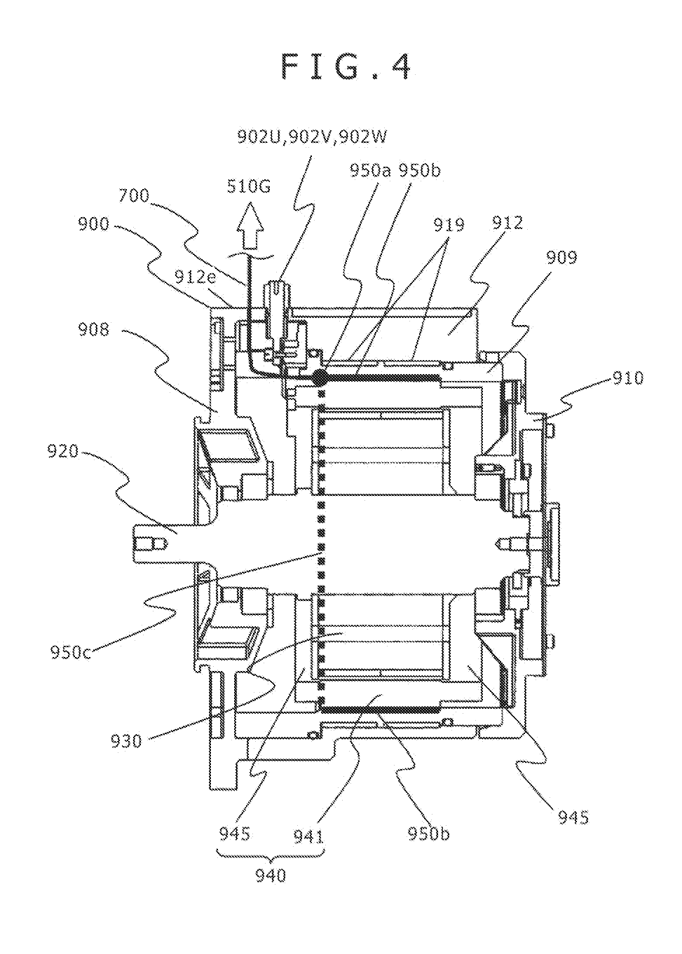

The outlet pipe 14 of the case 12 is connected via a junction member 14a to an inlet pipe 913 arranged on the housing 912 of the rotary electric machine 900. The coolant discharged from the outlet pipe 14 flows from the inlet pipe 913 of the housing 912 into a channel in the housing (channel 919 shown in FIG. 4, explained later). The coolant flows through the channel and is discharged from an outlet pipe 914 arranged on the periphery of the housing 912.

FIG. 4 is a cross-sectional view of the rotary electric machine 900. A stator 940 includes a stator core 941 and three-phase armature windings 945 attached to the stator core 941. The stator core 941 has been fixed to a center bracket 909 by means of shrink fitting (thermal shrink fitting). The rotor shaft 920, on which a rotor 930 has been fixed, is rotatably held at both ends by the front bracket 908 and the rear bracket 910. The rotor 930 is stored in the stator 940 with certain clearance in the radial direction to be freely rotatable in the stator 940.

On the periphery of the center bracket 909, grooves are formed to surround the stator core 941. The center bracket 909 is stored in the housing 912. In this state, the channel 919 is formed by the grooves of the center bracket 909 and the inner circumferential surface of the housing 912. AC terminals 902U-902W are arranged to protrude from a surface 912e of the housing 912. Corresponding armature windings 945 of the stator 940 are connected to the AC terminals 902U-902W.

The housing 912 and the center bracket 909 are fixed to the front bracket 908 by using bolts or the like (unshown). The rear bracket 910 is fixed to the housing 912 by using bolts or the like (unshown). While the exterior parts of the rotary electric machine 900 are made up of four parts (the housing 912, the center bracket 909, the front bracket 908 and the rear bracket 910) in this embodiment, it is unnecessary to adhere to this configuration. For example, it is also possible to form the housing 912 and the center bracket 909 as one component. Similarly, there is no problem even if the front bracket 908, the housing 912 and the center bracket 909 are formed as one component. Incidentally, electrically conductive material is used as the material of the housing 912, the center bracket 909, the front bracket 908 and the rear bracket 910. In this embodiment, the material is assumed to be die-cast aluminum as a metallic material.

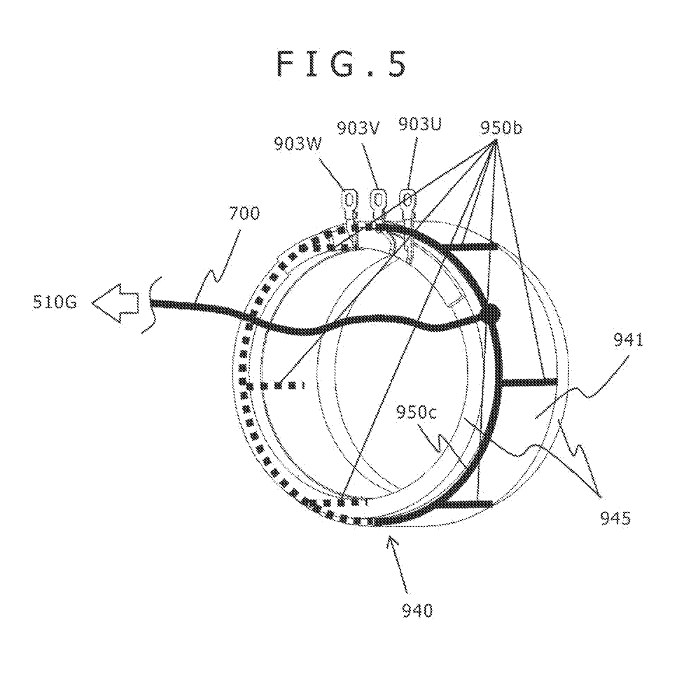

Further, in this embodiment, a plurality of conductor bars 950b extending in the axial direction of the stator core 941 and a conductor ring 950c extending one lap around the peripheral surface of the stator core 941 and connecting one ends of the conductor bars 950b together are arranged to be in contact with the periphery of the stator core 941. FIG. 5 is a perspective view of the stator 940 provided with the conductor ring 950c and the conductor bars 950b. The stator core 941 has the armature windings 945 for the three phases. At an end of the stator 940 in its axial direction, coil terminals 903U-903W to be connected to the AC terminals 902U-902W arranged on the housing 912 (see FIG. 4) are lead out.

The conductor bars 950b are arranged on the circumference of the stator core 941 at prescribed intervals in regard to the circumferential direction. In the rotary electric machine 900 having the structure shown in FIG. 4, the stator core 941 is fit in the inner circumference of the center bracket 909 by means of shrink fitting. The conductor bars 950b have been fixed in contact with the shrink-fit surface of the stator core 941. The stator core 941 is formed by stacking up a plurality of electromagnetic steel sheets cut out by use of a cutting die. Therefore, the conductor bars 950b are fixed to the peripheral surface of the stator core by welding or the like so as to achieve good contact with each electromagnetic steel sheet.

As will be explained later, the conductor bars 950b are provided in order to collect the common mode current (common mode noise) flowing into the stator. The number of the conductor bars 950b may be one; however, the current-collecting effect increases with the increase in the number of the conductor bars 950b. The common mode current flowing into the conductor bars 950b flows into the conductor ring 950c and is thereafter returned to a virtual neutral point 510G on the input side of the inverter circuit via a connection wire 700. The virtual neutral point 510G is also called a “virtual ground point”.

The connection wire 700 is lead to the inside of the case 12 while penetrating the part where the housing 912 and the case 12 face each other. The connection wire 700 is not lead out to the outside of the casing of the electric drive system 1. In the part where the housing 912 and the case 12 face each other, a through hole is formed through the base part of the case 12 and the AC terminals 902U-902W project to the inside of the case 12.

Incidentally, the above structure in which one connection wire 700 is lead out from the rotary electric machine's side to the power conversion device's side is not necessarily essential. For example, similarly to the AC terminals 902U-902W arranged on the housing 912 for the connection between the armature windings 945 and AC bus bars 802U-802W, it is possible to provide the housing 912 with a terminal part extending from the inside of the housing 912 to the inside of the case 12 and connect a connection wire on the rotary electric machine's side with a connection wire on the power conversion device's side via the terminal part.

While the conductor bars 950b and the conductor ring 950c are fixed on the peripheral surface of the stator core 941 in this embodiment as members for collecting the common mode current, any type of structure may be employed as long as the structure has the function of the current-collecting member. For example, it is possible to apply thick plating on the entire peripheral surface of the stator core 941 and connect the connection wire 700 to the plated part. It is also possible to give the function of the current-collecting member to a part of the stator core 941 by replacing a part of the electromagnetic steel sheets of the stator core 941 with a conductor plate, for example. Aluminum, copper, etc. are usable as the material of the current-collecting member.

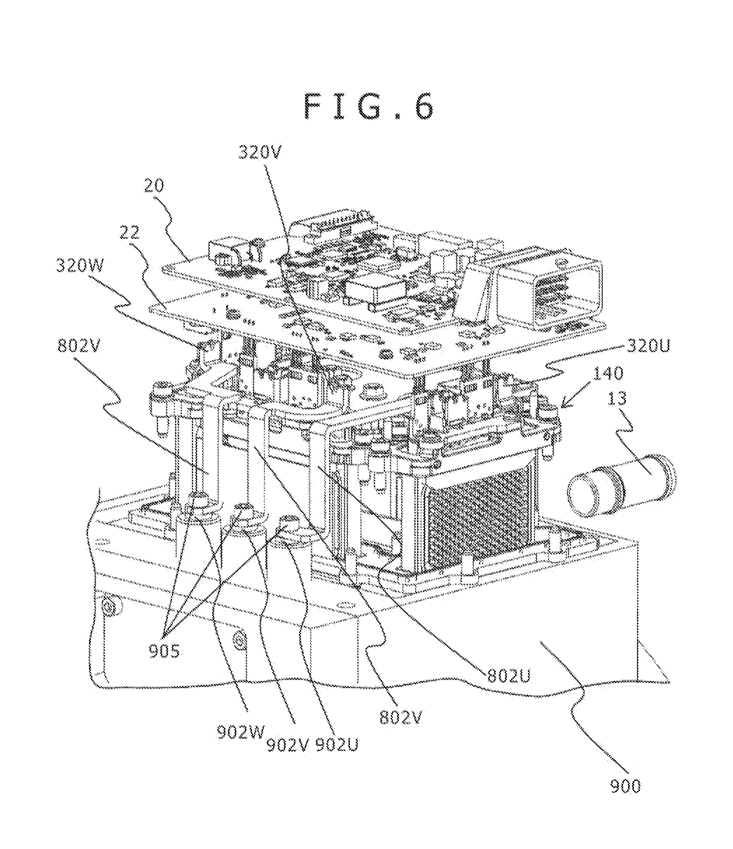

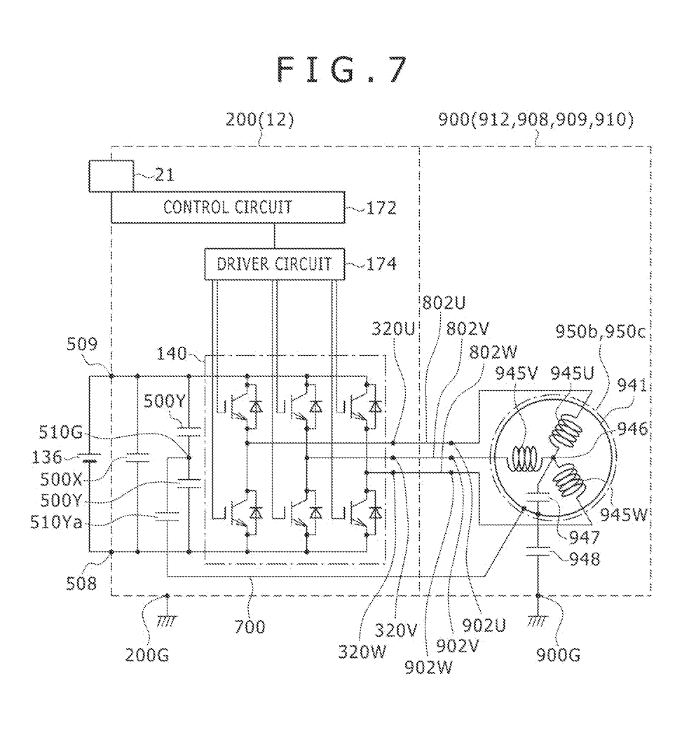

FIG. 6 is a schematic diagram showing the inside of the power conversion device 200 in detail (external perspective view of the power conversion device 200 shown in FIG. 2 from which the case 12 has been removed). FIGS. 7-9 are block diagrams for explaining the circuitry of the power conversion device 200.

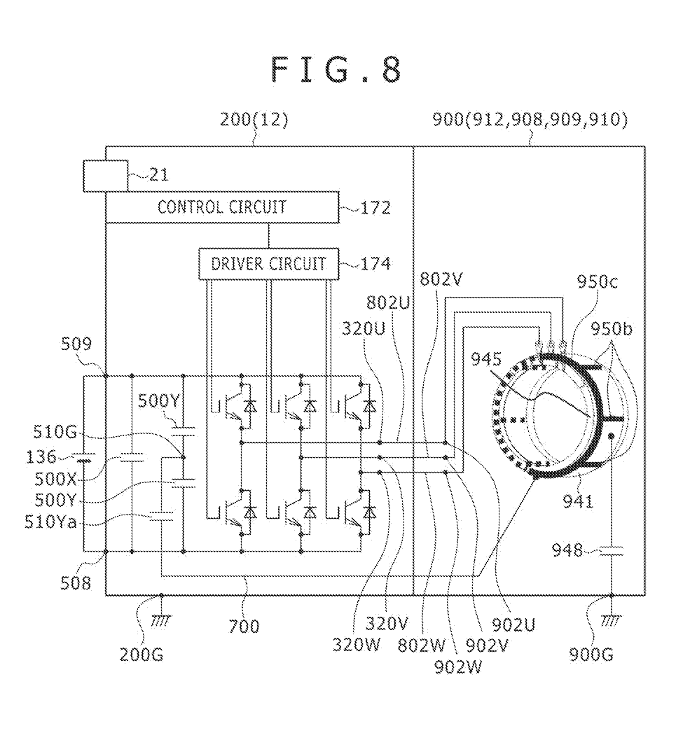

First, the circuitry of the power conversion device 200 will be explained by referring to FIGS. 7-9. The case 12, the housing 912, the front bracket 908 and the rear bracket 910 shown in FIG. 2 and the center bracket 909 shown in FIG. 4 are made of metallic material such as die-cast aluminum. As shown in FIG. 7, the housing 912 and the case 12 are fixed to the body of the vehicle by using bolts or the like and are electrically connected to chassis grounds 900G and 200G on the vehicle's side. While FIG. 8 shows the same circuitry as FIG. 7, the stator 940 in FIG. 8 is represented not by the circuit symbol of the stator 940 but by the stator 940 shown in FIG. 5.

As shown in FIG. 7, an inverter circuit 140 is electrically connected to the battery 136 via DC connectors (unshown). Electric power is transmitted between the battery 136 and the inverter circuit 140. When the rotary electric machine 900 is operated as a motor, the inverter circuit 140 generates AC power according to DC power supplied from the battery 136 and supplies the AC power to the rotary electric machine 900 via AC terminals 320U-320W. The AC terminals 320U-320W of the power conversion device 200 are connected to the AC terminals 902U-902W of the rotary electric machine 900 via the AC bus bars 802U-802W made of metal.

Incidentally, it is possible in this embodiment to drive the vehicle (for the traveling) with the power of the rotary electric machine 900 alone, by operating the rotary electric machine 900 as a motor by use of the electric power of the battery 136. Further, in this embodiment, the battery 136 can be charged by operating the rotary electric machine 900 as a generator by use of the power of the engine EGN or the power from the wheels.

Although illustration is omitted in FIG. 1, the battery 136 is used also as a power supply for driving motors for auxiliary machinery. The motors for the auxiliary machinery can include, for example, a motor for driving the compressor of the air conditioner or a motor for driving a hydraulic pump used for control. The auxiliary machinery power module, which is supplied with the DC power from the battery 136, generates AC power and supplies the generated AC power to the motors for the auxiliary machinery. The auxiliary machinery power module has basically the same circuitry and functions as the inverter circuit 140 and controls the phase, frequency and electric power of the AC power supplied to each of the motors for the auxiliary machinery. The power conversion device 200 has a capacitor 500X for smoothing the DC power supplied to the inverter circuit 140.

The power conversion device 200 has the connector 21 for communication. Via the connector 21, the power conversion device 200 receives commands from the upper-level control device, transmits data representing status to the upper-level control device, and so forth. Based on the commands inputted through the connector 21, a control circuit 172 of the power conversion device 200 calculates control values for the rotary electric machine 900, calculates (determines) whether the rotary electric machine 900 should be operated as a motor or as a generator, generates a control pulse based on the result of the calculation, and supplies the generated control pulse to a driver circuit 174. According to the supplied control pulse, the driver circuit 174 generates drive pulses for controlling the inverter circuit 140.

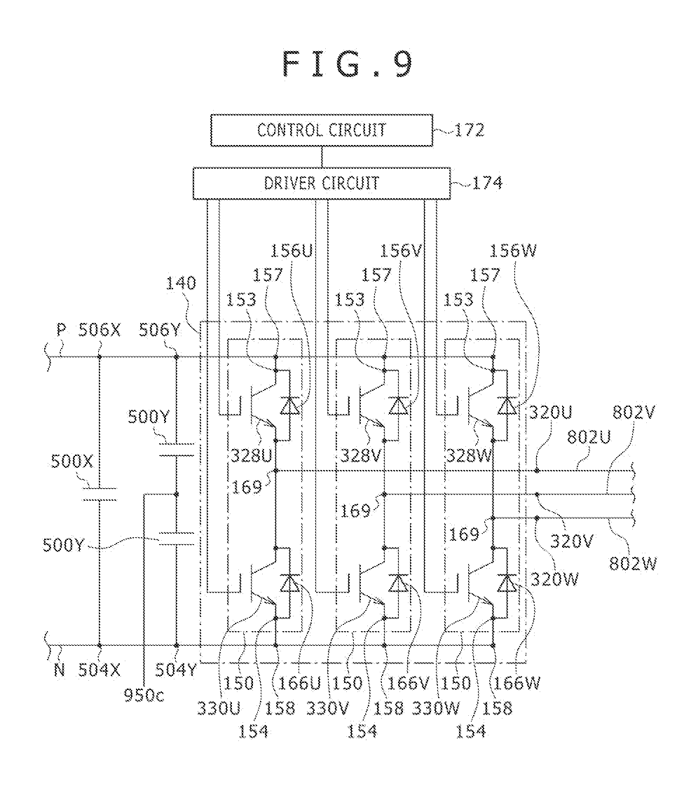

FIG. 9 is a schematic diagram for explaining the configuration of the inverter circuit 140. In the following explanation, semiconductor switching devices are implemented by insulated gate bipolar transistors (hereinafter abbreviated as “IGBTs”). The switching power semiconductor devices may also be implemented by use of metal-oxide-semiconductor field-effect transistors (hereinafter abbreviated as “MOSFETs”). In this case, diodes 156 and diodes 166 become unnecessary. In the use as the switching power semiconductor devices, IGBTs are suitable for cases where the DC voltage is relatively high, while MOSFETs are suitable for cases where the DC voltage is relatively low.

Series circuits 150U-150W are formed by upper and lower arms. Here, IGBTs 328U-328W and diodes 156U-156W operate as the upper arm, and IGBTs 330U-330W and diodes 166U-166W operate as the lower arm. The inverter circuit 140 has the three series circuits 150 corresponding to the U-phase, V-phase and W-phase of the AC power to be outputted.

These three phases correspond to the three-phase armature windings (U-phase, V-phase, W-phase) of the rotary electric machine 900 in this embodiment. The upper/lower arm series circuit 150 for each of the three phases outputs AC current from an intermediate electrode 169 as the midpoint of the series circuit. The intermediate electrodes 169 are connected to the AC terminals 902U-902W of the rotary electric machine 900 via the AC terminals 320U-320W. As mentioned above, the AC terminals 320U-320W are connected to the AC terminals 902U-902W via the AC bus bars 802U-802W.

The collector electrode 153 of the upper arm IGBT 328 is electrically connected to positive capacitor terminals 506Y and 506X of capacitors 500Y (constituting a Y capacitor) and the smoothing capacitor 500X via a positive terminal 157. Meanwhile, the emitter electrode 154 of the lower arm IGBT 330 is electrically connected to negative capacitor terminals 504Y and 504X of the capacitors 500Y and 500X via a negative terminal 158. The connection wire 700, which is connected to the conductor ring 950c at one end (see FIGS. 7 and 8), is connected to the virtual neutral point 510G (as the midpoint of the two capacitors 500Y) via a capacitor 510Ya.

The capacitor 500X has the positive capacitor terminal 506X, the negative capacitor terminal 504X, the positive power supply terminal 509 and the negative power supply terminal 508. High-voltage DC power from the battery 136 is supplied to the positive and negative power supply terminals 509 and 508. Then, the high-voltage DC power is supplied from the positive and negative capacitor terminals 506X and 504X of the capacitor 500X to the inverter circuit 140.

On the other hand, the DC power obtained by the inverter circuit 140 by the conversion of the AC power is supplied to the capacitor 500X via the positive and negative capacitor terminals 506X and 504X, supplied from the positive and negative power supply terminals 509 and 508 to the battery 136 via the DC connectors (unshown), and stored in the battery 136.

The control circuit 172 includes a microcomputer for calculating the switching timing of the IGBTs 328 and the IGBTs 330. Information inputted to the microcomputer includes a target torque value which is required to be generated by the rotary electric machine 900, values of electric currents supplied from the series circuits 150 to the rotary electric machine 900, and the magnetic pole position of the rotor of the rotary electric machine 900.

The target torque value is a value based on a command signal supplied from the unshown upper-level control device. The electric current values are detected based on detection signals from a current sensor (unshown) installed in the power conversion device 200. The magnetic pole position is detected based on a detection signal from a rotary magnetic pole sensor (unshown) such as a resolver installed in the rotary electric machine 900.

The microcomputer in the control circuit 172 calculates d-axis and q-axis current command values for the rotary electric machine 900 based on the target torque value, calculates d-axis and q-axis voltage command values based on the differences between the calculated d-axis and q-axis current command values and detected d-axis and q-axis current values, and converts the calculated d-axis and q-axis voltage command values into U-phase, V-phase and W-phase voltage command values based on the detected magnetic pole position. Then, the microcomputer generates pulse-like modulation waves based on comparison between a carrier wave (triangular wave) and fundamental waves (sinusoidal waves) based on the U-phase, V-phase and W-phase voltage command values (hereinafter referred to as “PWM control”), and outputs the generated modulation waves to the driver circuit 174 as PWM (pulse-width modulation) signals.

According to the above control pulse, the driver circuit 174 supplies the drive pulses (for controlling the IGBTs 328 and 330 constituting the upper and lower arms of the three-phase series circuits 150) to the IGBTs 328 and 330 for the three phases. For driving the lower arm, the driver circuit 174 amplifies each PWM signal and outputs the amplified PWM signal to the gate electrode of each corresponding lower arm IGBT 330 as a drive signal. For driving the upper arm, the driver circuit 174 amplifies each PWM signal after shifting the reference electric potential level of the PWM signal to that of the upper arm, and outputs the amplified PWM signal to the gate electrode of each corresponding upper arm IGBT 328 as a drive signal. The IGBTs 328 and 330 perform the conduction/interruption operation according to the drive pulses from the driver circuit 174 and thereby convert the DC power supplied from the battery 136 into three-phase AC power. The three-phase AC power obtained by the conversion is supplied to the rotary electric machine 900.

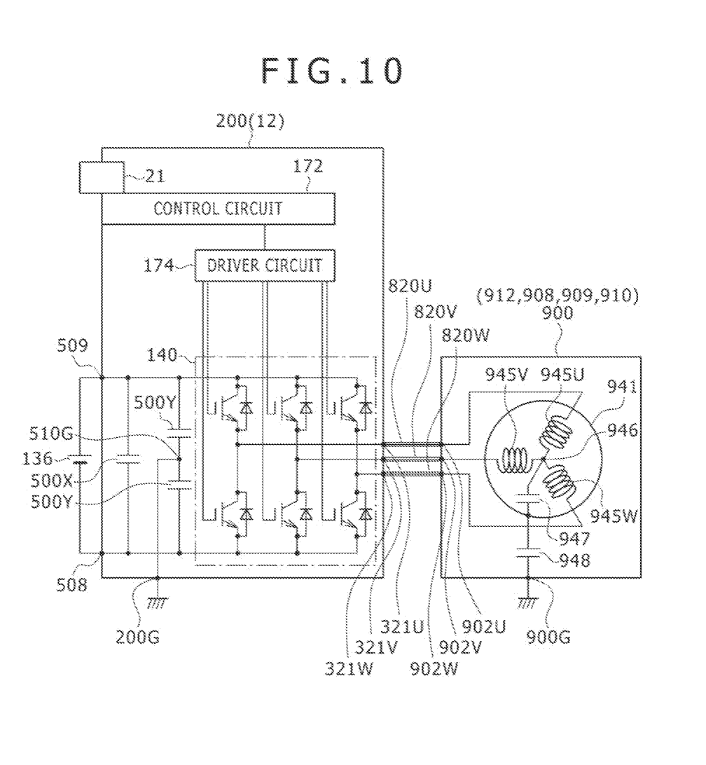

In a conventional electric drive system in which the power conversion device 200 and the rotary electric machine 900 are provided separately, AC terminals 321U-321W of the power conversion device 200 are connected to the AC terminals 902U-902W of the rotary electric machine 900 generally via shield cables 820U-820W as shown in FIG. 10. In general, AC output terminals of the series circuits 150 are connected to the AC terminals 321U-321W of the power conversion device 200 by using bus bars made of metal, and the shield cables 820U-820W are connected to the AC terminals 321U-321W.

In contrast, in the electric drive system of this embodiment, the power conversion device 200 and the rotary electric machine 900 are integrated into one body as shown in FIG. 2. Therefore, one ends of the AC bus bars 802U-802W (which are connected to the AC terminals 320U-320W of the series circuits 150 at the other ends) are directly connected to the AC terminals 902U-902W of the rotary electric machine 900 as shown in FIG. 6. In short, the shield cables 820U-820W are left out. Over the inverter circuit 140, a driver circuit board 22 (on which the driver circuit 174 has been mounted) and a control circuit board 20 (on which the control circuit 172 has been mounted) are arranged in turn.

A side face of the case 12 of the power conversion device 200 is provided with an inlet pipe 13 and an outlet pipe 14 for the cooling water (coolant). The three-phase inverter circuit 140 and nearby components are cooled down by the circulation of the coolant through a coolant channel (unshown) arranged in the power conversion device 200.

Next, the functions of the conductor bars 950b, the conductor ring 950c and the connection wire 700 shown in FIG. 5 (as characteristic features of this embodiment) will be described below. First, the common mode noise (also called “common mode current”) in a conventional electric drive system will be explained by referring to FIGS. 10-12. Let Vu, Vv and Vw stand for the phase voltages of the three-phase armature windings 945U-945W, the electric potential V0 of a neutral point 946 of the three-phase armature windings 945U-945W is represented by the following expression (1):

V0=(Vu+Vv+Vw)/3 (1)

Assuming that the voltage of the battery 136 is Vdc and the intermediate electric potential of DC bus lines P and N (see FIG. 9) is 0 (as the virtual neutral point), the electric potential P equals Vdc/2 and the electric potential N equals −Vdc/2. The midpoint 510G of the two capacitors 500Y is this virtual neutral point.

The phase voltages of the U-phase, V-phase and W-phase change as follows according to the ON/OFF operation of the upper arm IGBTs 328U-328W and the lower arm IGBTs 330U-330W of the inverter circuit 140:
U-phase: (328U, 330U)=(ON, OFF)=Vdc/2
U-phase: (328U, 330U)=(OFF, ON)=−Vdc/2
V-phase: (328V, 330V)=(ON, OFF)=Vdc/2
V-phase: (328V, 330V)=(OFF, ON)=−Vdc/2
W-phase: (328W, 330W)=(ON, OFF)=Vdc/2
W-phase: (328W, 330W)=(OFF, ON)=−Vdc/2

When the PWM control is performed as described above, the switching pattern of the upper arm IGBTs 328U-328W and the lower arm IGBTs 330U-330W of the inverter circuit 140 includes the following eight modes:
mode 0: (U, V, W)=(000)
mode 1: (U, V, W)=(100)
mode 2: (U, V, W)=(110)
mode 3: (U, V, W)=(010)
mode 4: (U, V, W)=(011)
mode 5: (U, V, W)=(001)
mode 6: (U, V, W)=(101)
mode 7: (U, V, W)=(111)
   where the number “1” represents the state in which the upper arm is ON and the lower arm is OFF and the number “0” represents the state in which the upper arm is OFF and the lower arm is ON.

The neutral point electric potential V0 in each of the above modes 0-7 is calculated by use of the above expression (1) as follows:
mode 0: V0=(−Vdc/2−Vdc/2−Vdc/2)/3=−Vdc/2
mode 1: V0=(Vdc/2−Vdc/2−Vdc/2)/3=−Vdc/6
mode 2: V0=(Vdc/2+Vdc/2−Vdc/2)/3=Vdc/6
mode 3: V0=(−Vdc/2+Vdc/2−Vdc/2)/3=−Vdc/6
mode 4: V0=(−Vdc/2+Vdc/2+Vdc/2)/3=Vdc/6
mode 5: V0=(−Vdc/2−Vdc/2+Vdc/2)/3=−Vdc/6
mode 6: V0=(Vdc/2−Vdc/2+Vdc/2)/3=Vdc/6
mode 7: V0=(Vdc/2+Vdc/2+Vdc/2)/3=Vdc/2

In PWM control, the modes are generally repeated like “7→6→1→0→1→6→7→6→1→0→1→2→7→2 1→0→1→2→7→ . . . ” along with the switching of the upper and lower arms. Accordingly, the neutral point voltage repeats an electric potential change by Vdc/3 like “Vdc/2, Vdc/6, −Vdc/6, −Vdc/2, −Vdc/6, Vdc/6→ . . . ”.

When the electric potential of the neutral point 946 changes as above, the stray capacitance 947 (stray capacitance between the stator core and the windings) repeats the charging and discharging. Therefore, the common mode current flows from the stator core 943 to the center bracket 909 which is in metallic contact with the stator 941. The common mode current flows further to the housing 912, the front bracket 908 and the rear bracket 910.

While stray capacitance 948 between the stator core 941 and the housing 912, the front bracket 908 and the rear bracket 910 is lower than the stray capacitance 947, the stray capacitance 948 is provided since the stator core 941, the center bracket 909, the housing 912, the front bracket 908 and the rear bracket 910 are fixed by means of surface contact such as shrink fitting and bolting.

Incidentally, in cases where the power conversion device 200 and the rotary electric machine 900 are provided separately as in FIG. 10, a countermeasure can be taken against the common mode current by employing a configuration like the one shown in FIG. 10 instead of an additional noise reduction circuit for reducing the common mode current as in the invention described in Patent Document 1. By connecting the AC terminals 321U-321W of the power conversion device 200 to the AC terminals 902U-902W of the rotary electric machine 900 by using the shield cables 820U-820W as shown in FIG. 10, the circulation of the common mode current from the chassis ground 900G to the chassis ground 200G via the vehicle can be prevented with ease.

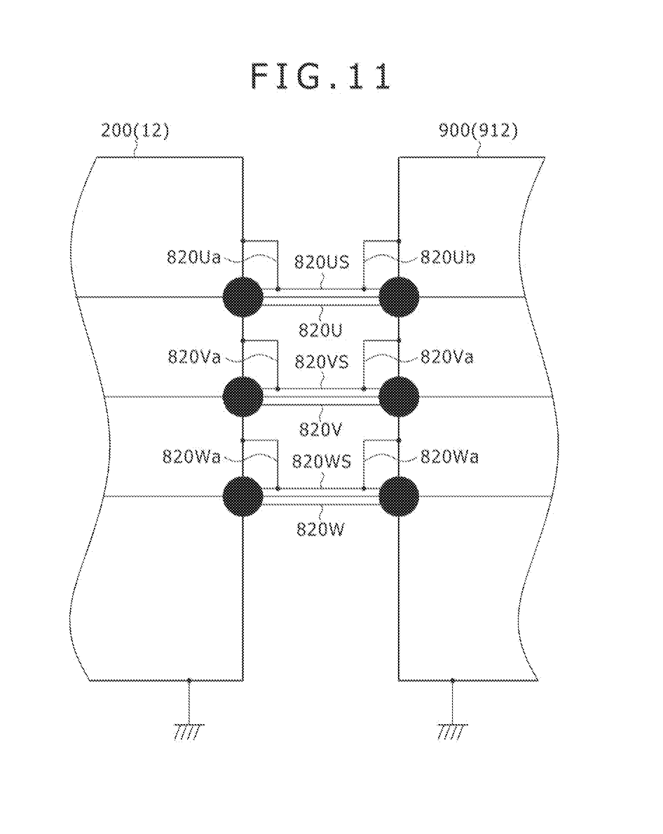

FIG. 11 is a schematic diagram magnifying a part of FIG. 10 around the shield cables 820U-820W. In FIG. 10, an end of a shield 820US of the shield cable 820U is connected to the case 12 of the power conversion device 200 by using a connection member 820Ua and the other end of the shield 820US is connected to the housing 912 of the rotary electric machine 900 by using a connection member 820Ub. Similarly, an end of a shield 820VS of the shield cable 820V is connected to the case 12 by using a connection member 820Va and the other end of the shield 820VS is connected to the housing 912 by using a connection member 820Vb. Similarly, an end of a shield 820WS of the shield cable 820W is connected to the case 12 by using a connection member 820Wa and the other end of the shield 820WS is connected to the housing 912 by using a connection member 820Wb.

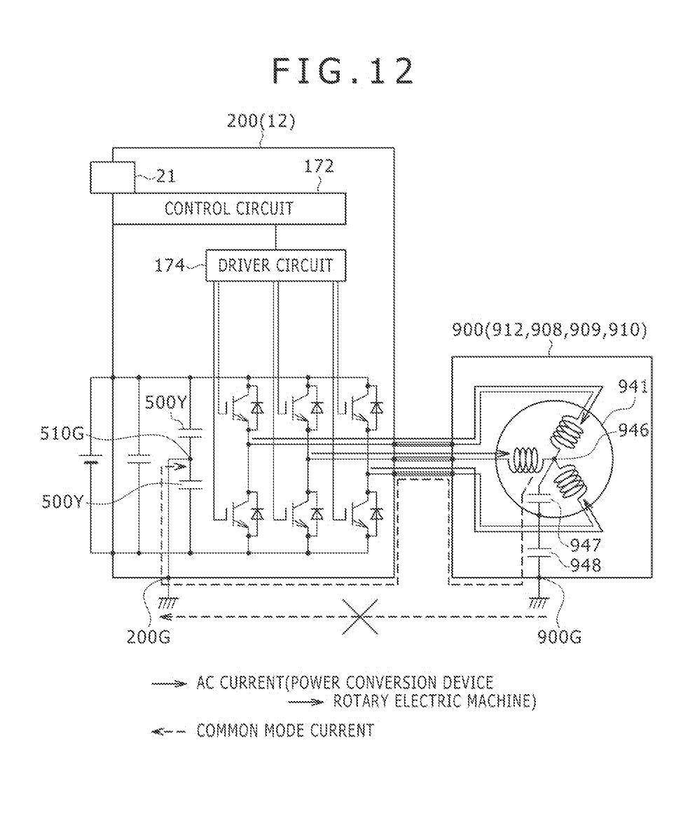

As indicated by the broken lines in FIG. 12, the common mode current deriving from the switching of the IGBTs 328U-328W and 330U-330W of the inverter circuit 140 flows to the neutral point 946, the stator core 941, the housing 912, the shields 802US-802WS and the case 12 and returns to the virtual neutral point 510G of the capacitors 500Y of the power conversion device 200. As above, in the conventional electric drive system, the common mode noise (common mode current) circulating between the chassis grounds 900G and 200G can be reduced by configuring the system to allow the common mode current to flow along the path: housing 912→shields 802US-802WS→case 12→virtual neutral point 510G. Incidentally, the virtual neutral point 510G is connected to the chassis ground 200G of the power conversion device 200.

However, the countermeasure by use of the shield cables 820U-820W shown in FIGS. 10-12 cannot be employed in the mechanical-electrical integrated electric drive system 1 of this embodiment since the AC bus bars 802U-802W of the power conversion device 200 are directly connected to the AC terminals 902U-902W of the rotary electric machine 900 as shown in FIG. 6.

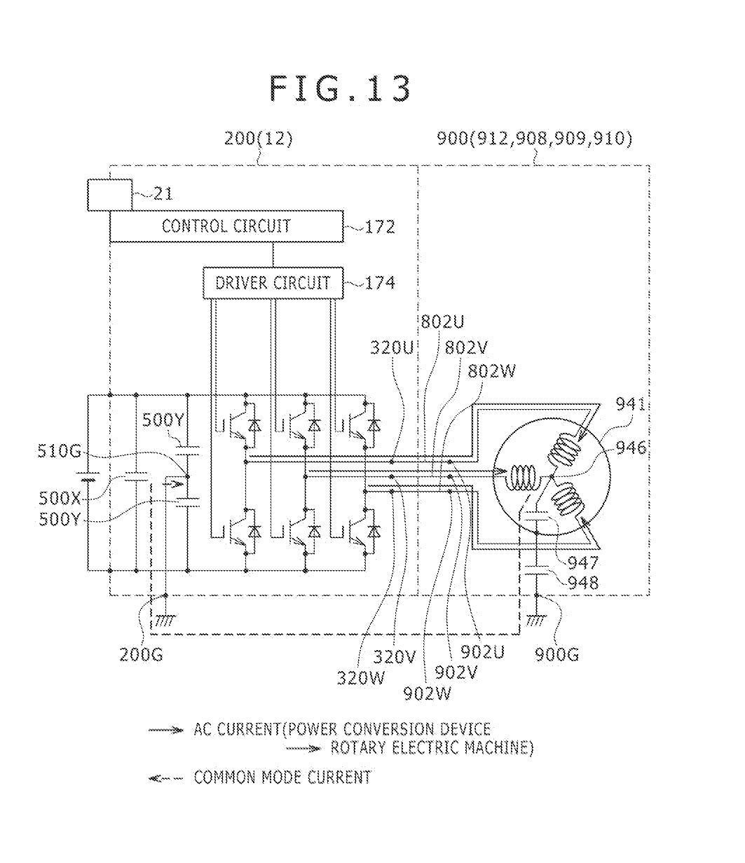

For example, in a configuration in which the shield cables 820U-820W in FIG. 10 are simply replaced with the AC bus bars 802U-802W as shown in FIG. 13, the common mode current flows from the chassis ground 900G on the rotary electric machine's side to the chassis ground 200G on the power conversion device's side via the vehicle as indicated by the broken lines. Thus, the common mode current (common mode noise) exerts bad influence on the control device on the vehicle's side (the aforementioned upper-level control device) and the control circuit 172 of the power conversion device 200. In general, the control circuit 172 as light electrical equipment (electronics equipment) is grounded through a system separate from the chassis ground 200G. In this case, the common mode current flows into the control circuit 172 from the ground (separate system).

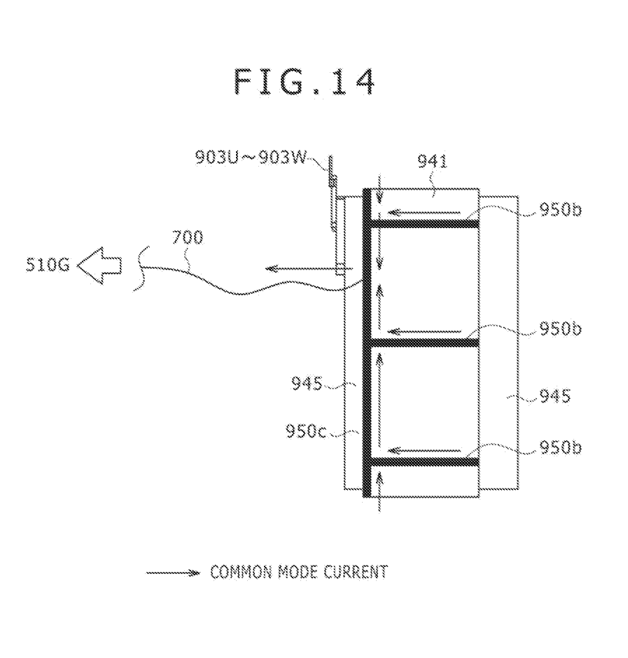

In contrast, in this embodiment, the conductor bars 950b and the conductor ring 950c are arranged on the peripheral surface of the stator core 941 and the conductor ring 950c is connected to the virtual neutral point 510G of the power conversion device 200 by using the connection wire 700 as shown in FIG. 14. Further, the connection wire 700 is arranged inside the casing of the rotary electric machine 900 and the power conversion device 200 as shown in FIG. 7.

Since the conductor bars 950b are configured to be in electrical connection with the stator core 941, the common mode current entering the stator core 941 flows not into the shrink fitting surface between the stator core 941 and the center bracket 909 but into the conductor bars 950b and the conductor ring 950c as indicated by the arrows in FIG. 14 if the conduction resistance of the conductor bars 950b has been set sufficiently low.

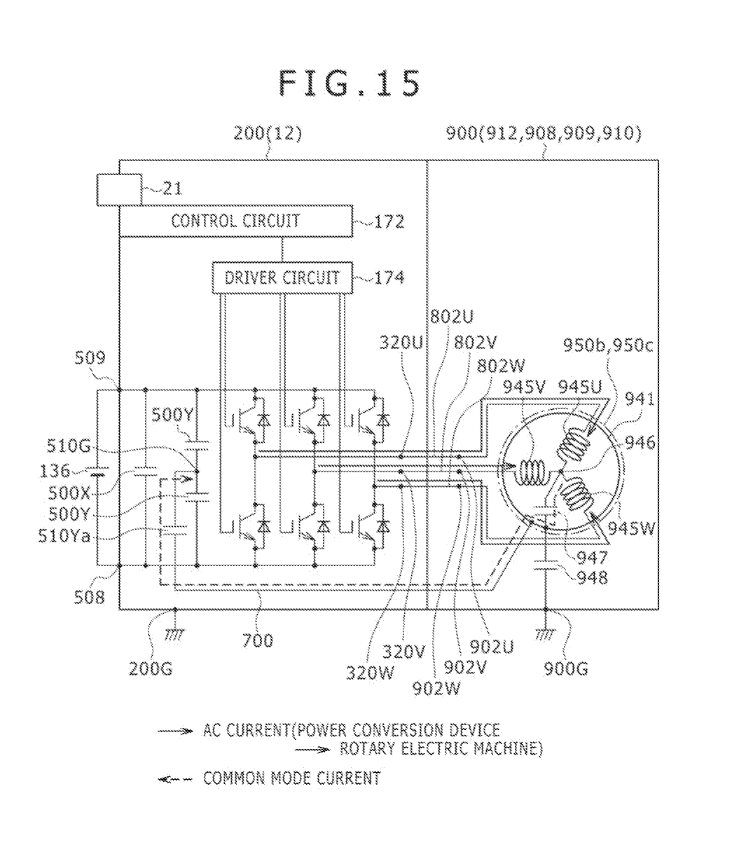

The common mode current flowing into the conductor bars 950b and the conductor ring 950c is lead by the connection wire 700 from the rotary electric machine 900's side to the power conversion device 200's side and flows into the virtual neutral point 510G via the capacitor 510Ya as shown in FIG. 15. Incidentally, the virtual neutral point 510G is not connected to the chassis ground 200G in this embodiment. While the connection wire 700 is connected to the virtual neutral point 510G via the capacitor 510Ya, the capacitor 510Ya may either be provided or left out depending on the level of the noise occurring in the system. Providing the capacitor 510Ya is desirable when the noise level is high.

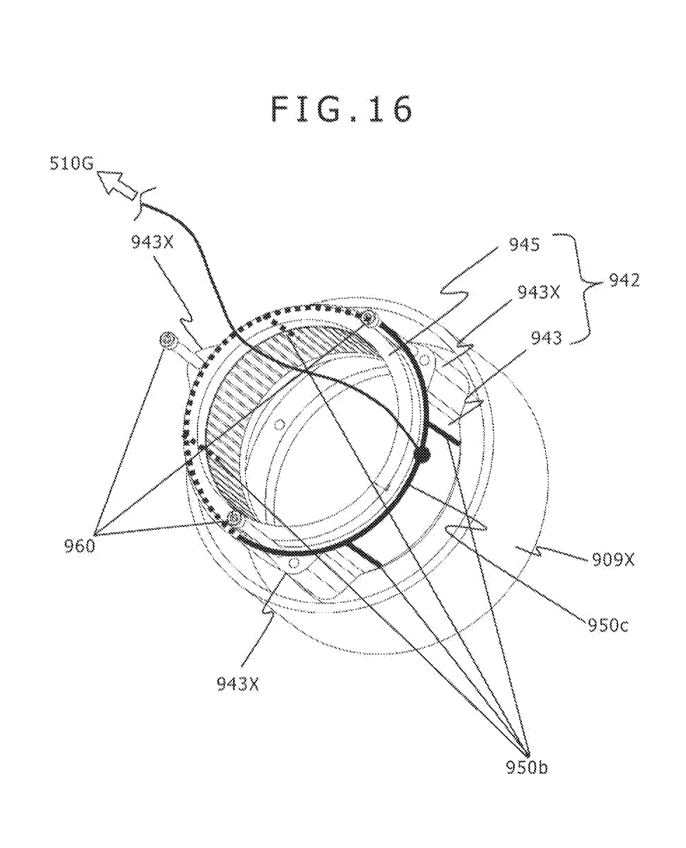

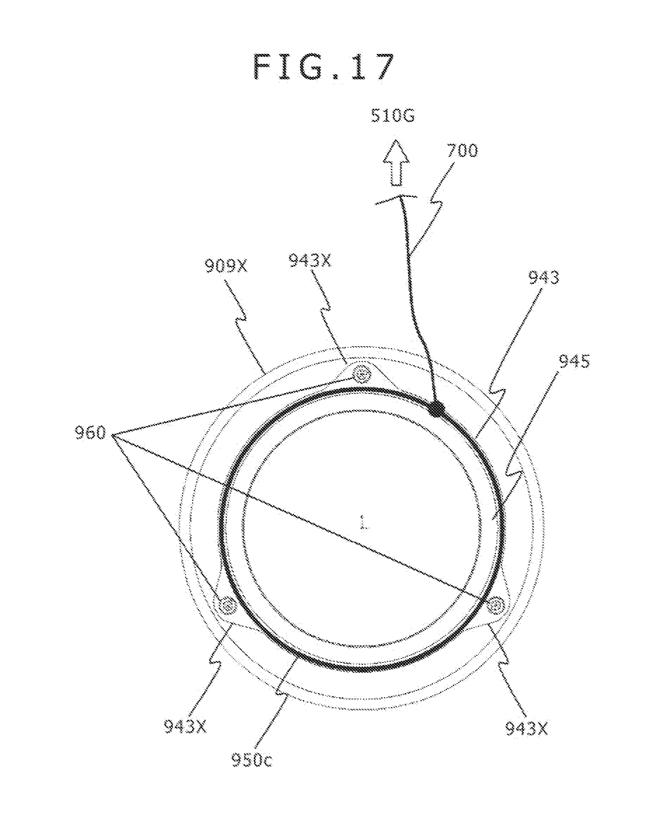

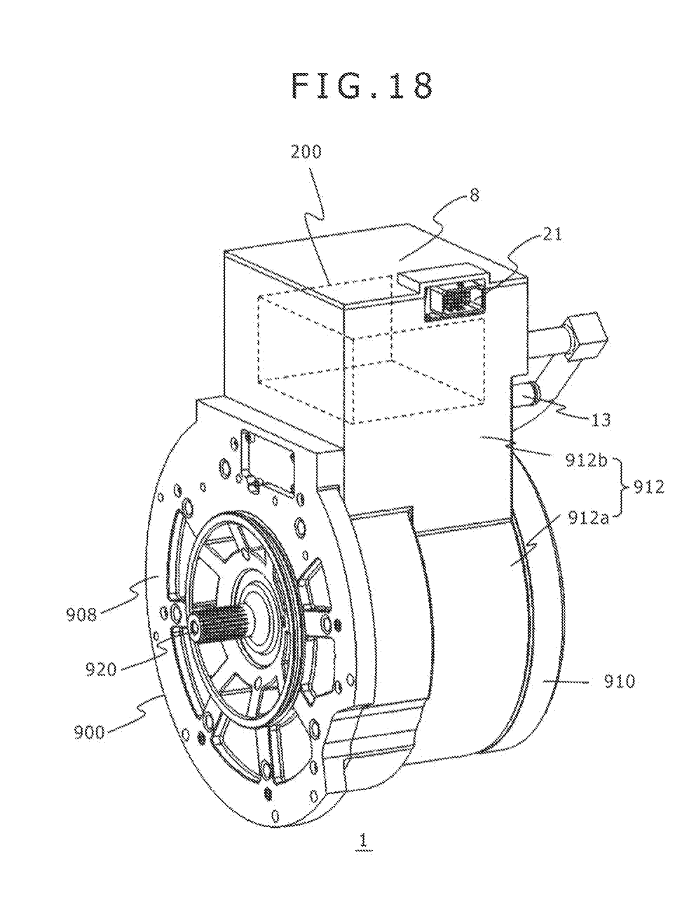

While the stator core 941 is fit in the inner circumference of the center bracket 909 by means of shrink fitting and the center bracket 909 is fixed to the housing 912 in the above embodiment, the present invention is not to be restricted to stators 940 having such a configuration. FIGS. 16 and 17 are schematic diagrams showing an example of a different configuration of the stator 940, wherein FIG. 16 is a perspective view and FIG. 18 shows a cross section orthogonal to the rotor shaft.

A stator 942 has a stator core 943 and three-phase armature windings 945. The peripheral surface of the stator core 943 is provided with a plurality of fixation parts 943X each having a through hole for a bolt. The stator core 943, stored in an inner circumferential part of a center bracket 909X, is fastened to the center bracket 909X by using bolts 960.

At least one conductor bar 950b extending in the axial direction of the stator core 943 is arranged on the peripheral surface of the stator core 943 to be in electrical connection with the stator core 943. Each conductor bar 950b is electrically connected to a conductor ring 950c which is arranged in the vicinity of an end of the stator core 943 in the axial direction. A connection wire 700 is connected to the conductor ring 950c. As explained above, the stator 942 in this example has a configuration equivalent to the above embodiment in regard to the collection of the common mode current.

In this configuration, a clearance is formed between the stator core 943 and the center bracket 909X, by which the common mode current flowing from the stator core 943 to the center bracket 909X's side can be reduced. Consequently, the common mode current can be collected more efficiently by using the conductor bars 950b and the conductor ring 950c.

FIG. 18 is a perspective view showing another embodiment of the mechanical-electrical integrated electric drive system. In this embodiment, a first housing part 912a for storing the stator 940 and a second housing part 912b for storing the power conversion device 200 are formed integrally in the housing 912 of the rotary electric machine 900. In this case, the case 12 of the power conversion device 200 is left out and the components inside the case 12 are directly arranged in the housing part 912b.

With such a configuration, the fixing part (joint) between the case 12 of the power conversion device 200 and the housing 912 of the rotary electric machine 900 shown in FIG. 2 is eliminated. This configuration makes it easier to confine the common mode current in the casing of the electric drive system 1. Consequently, the radiated noise can be reduced. Further, cost reduction can be achieved in comparison with the configuration of FIG. 2 since the case 12 of the power conversion device 200 can be left out.

(a) As described above, the electric drive system 1 comprises: a rotary electric machine 900 which includes a rotor 930, a stator 940 having a stator core 941 mounting armature windings 945 thereon, and a housing 912 holding the stator 940 and having AC terminals 902U-902W of the armature windings 945 arranged thereon; and a power conversion device 200 which is fixed to the periphery of the housing 912 and includes an inverter circuit 140 and AC bus bars 802U-802W connecting the inverter circuit 140 with the AC terminals 902U-902W. The mechanical-electrical integrated electric drive system is configured to comprise: a conductor bar 950b and a conductor ring 950c as current-collecting members arranged in contact with the peripheral surface of the stator core 941 to collect common mode current deriving from stray capacitance of the stator 940; and a connection wire 700 which connects the conductor ring 950c to a virtual neutral point 510G on the DC input side of the inverter circuit 140.

Therefore, the common mode current flows into the conductor bar(s) 950b and then flows into the virtual neutral point 510G on the DC input side of the inverter circuit 140 via the conductor ring 950c and the connection wire 700 as shown in FIG. 15. Consequently, the inflow of the common mode current into the control circuit 172 and the control device on the vehicle's side can be prevented. As above, according to the embodiment, the reduction of the common mode noise can be achieved with the above-described simple configuration, without the need of providing a special noise reduction circuit like the one described in Patent Document 1.

(b) In the structure in which the metallic case 12 of the power conversion device 200 is fixed to the housing 912 of the rotary electric machine 900, the following configuration is desirable for preventing the bad influence of the common mode current on other devices: The connection wire 700 connected to the conductor ring 950c is lead from the inside of the housing 912 to the inside of the case 12 while penetrating a fixation surface where the housing 912 and the case 12 face each other (i.e., the surface 912e of the housing 912 shown in FIG. 4 and the base of the case 12).

(c) It is desirable to configure the housing 912 to include a first housing part 912a storing the stator core 941 and a second housing part 912b formed integrally with the first housing part 912a and storing the power conversion device 200. With such a configuration, the joint between the casing of the power conversion device 200 and the housing of the rotary electric machine is eliminated. This makes it easier to confine the common mode current in the metallic casing. Consequently, the radiated noise can be reduced.

The embodiments described above may be employed either individually or in combination since the effects of the embodiments can be achieved either individually or in a synergistic manner. The present invention is not to be restricted to the above embodiments; a variety of modifications, design changes, etc. to the embodiments are possible as long as the features of the present invention are not impaired.

### DESCRIPTION OF REFERENCE CHARACTERS

1: electric drive system
12: case
20: control circuit board
22: driver circuit board
140: inverter circuit
172: control circuit
174: driver circuit
200: power conversion device
200G, 900G: chassis ground
320U-320W, 321U-321W, 902U-902W: AC terminal
500X, 500Y, 500Ya: capacitor
510G, 946: virtual neutral point
700: connection wire
802U-802W: AC bus bar
900: rotary electric machine
909: center bracket
912: housing
912a: first housing part
912b: second housing part
930: rotor
940, 942: stator
941, 943: stator core
943X: fixation part
945: armature winding
950b: conductor bar
950c: conductor ring

1.-6. (canceled)

7. A mechanical-electrical integrated electric drive system comprising:
a rotary electric machine including a rotor, a stator, and a housing, the stator having a stator core mounted with armature windings, the housing holding the stator and having AC terminals of the armature windings arranged thereon; and
a power conversion device fixed to the periphery of the housing, the power conversion device including an inverter circuit and AC bus bars connecting the inverter circuit with the AC terminals, wherein
the mechanical-electrical integrated electric drive system includes
a current-collecting member arranged in contact with the stator core to collect common mode current deriving from stray capacitance of the stator, and
a connection wire connecting the current-collecting member to a virtual neutral point on the DC input side of the inverter circuit,
the power conversion device has a metallic casing storing the inverter circuit and the AC bus bars, the power conversion device being fixed to the periphery of the housing, and
the connection wire connected to the current-collecting member at one end is lead from the inside of the housing to the inside of the metallic casing, the connection wire penetrating a fixation surface where the housing and the metallic casing face each other, the connection wire being connected to the virtual neutral point.

8. The mechanical-electrical integrated electric drive system according to claim 7, wherein the housing includes a first housing part storing the stator core and a second housing part formed integrally with the first housing part and storing the power conversion device.

9. The mechanical-electrical integrated electric drive system according to claim 7, wherein the connection wire is connected to the virtual neutral point via a capacitor.

10. The mechanical-electrical integrated electric drive system according to claim 7, wherein
the current-collecting member includes at least one conductor bar and a conductor ring, the conductor bar being fixed on the peripheral surface of the stator core to extend in the axial direction of the rotary electric machine, the conductor ring being connected to an end of the conductor bar to surround the peripheral surface of the stator core, and
the connection wire is connected to the conductor ring.

11. The mechanical-electrical integrated electric drive system according to claim 7, wherein
the stator core has a fastening part at the periphery thereof to be fastened to the housing, and
the fastening part is fastened to the housing so that the stator is held by the housing.
